(19) United States
(12) Patent Application Publication
(10) Pub. No.: US 2016/0368261 A1
(43) Pub. Date: Dec. 22, 2016

(54) Method for Decorating an Item Including a Heat-Stable Coating by Flexography

(71) Applicant: SEB S.A.

(72) Inventors: Stephanie Le Bris, Chambery (FR); Laurent Caillier, Meythet (FR)

(21) Appl. No.: 15/101,185

(22) PCT Filed: Dec. 1, 2014
(86) PCT No.: PCT/FR2014/053104

§ 371 Date: Jun. 2, 2016

(30) Foreign Application Priority Data
Dec. 3, 2013 (FR) 1362044

(51) Int. Cl. B41F 23/04

(52) U.S. Cl. CPC B41F 23/04

(57) ABSTRACT

Provided is a decoration method in which a decoration using specific heat-stable inks is applied by flexography to a non-stick coating made of fluorocarbon resin, the decoration optionally consisting of colored hyperrealistic patterns.

This invention pertains in general to a method for decorating an item, particularly a cooking tool.

More specifically, this invention pertains to a decoration method in which a decoration using heat-stable particulate inks (or compositions) is applied by flexography to a fluorocarbon resin-based non-stick coating, the decoration optionally consisting of colored hyper-realistic patterns.

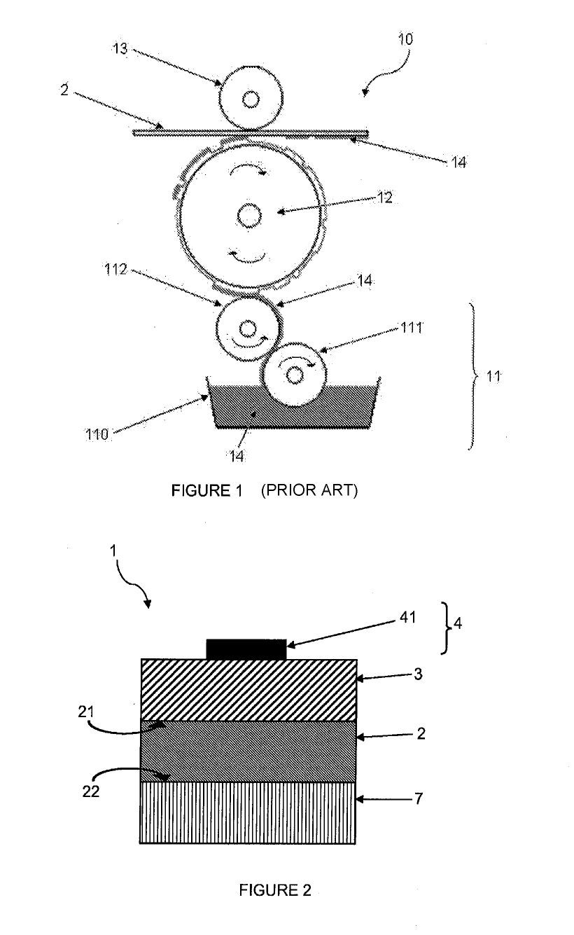

The method of flexography is a known, direct-transfer, relief printing method that makes it possible to print colored hyper-realistic patterns. It appeared around 1860 in the United States and then in England, and in the Alsace region of France in 1905. It is an aniline marking method that was named “flexography” in 1952. This method uses a device that is generally referred to as a flexographic printing system (10), illustrated in FIG. 1. The flexographic printing system (10) in FIG. 1 consists of an inking unit (11), a plate holder cylinder (or roller) (12) and a counter-pressure cylinder (or roller) (13). The inking unit (11) makes it possible to control and adjust the supply of ink to the plate. It generally consists of an inkwell (110), a fountain cylinder (or roller) (111), a webbed inking cylinder (or roller) (112) referred to as an “anilox” and a wiper (not depicted in FIG. 1). The operating principle of the flexographic printing system (10) is as follows:
The ink (14) is transferred from the inkwell (110) to the anilox cylinder (112) by means of the fountain roller (111);
The anilox cylinder (112) inks the plate holder roller (12), which transfers the ink to the medium (2) being printed using light pressure applied by the counter-pressure cylinder (13).

This printing method is primarily used in the field of packaging, and particularly cardboard packaging. Flexography is also used for decorating enamel-coated cooking tools, as is the case, for example, for cooking tools sold by the company Tramontina. However, these items lack durability with wear, due particularly to the poor thermal resistance of the enamels and inks used in the decoration. Indeed, these are coatings based on a polyester silicone binder and organic pigments.

Patent JPH 10 264295 describes a method for making a steel sheet non-stick and heat resistant. The method described in this document includes the supply of a medium, the application of a non-stick colored paint comprising a mixture of heat-resistant resin and fluororesin, an initial baking of the entire set, the formation of a non-stick layer printed by flexography, and the final baking of the entire set. This method therefore includes a double-baking, which presents the following disadvantages:
Poor printing quality is obtained. Indeed, the first baking at a temperature on the order of 400° C. results in a sintering of the fluorinated resin of the first layer, and therefore the formation of a very non-stick coating. This surface is completely hydrophobic and very slippery. Therefore, it is not possible to print a high-quality decoration on it, especially by flexography, which is a contact-based technique.
The second printed layer has a weak interaction with the first layer, which has already been baked, and the risk of cleavage of the final coating is very high.
Double baking requires time and results in significant energy consumption, which makes it expensive.

To remedy all of these disadvantages, the applicant has developed a method of decorating an item, allowing for printing by flexography of particulate pigmented decorative compositions (or inks) with good thermal resistance, preferably of an inorganic nature, on a heat-stable coating with a base of fluorocarbon resin, which is known for its chemical and mechanical resistance at high temperatures.

The term “particulate composition (or ink)” refers, for the purposes of the invention, to a composition existing in the form of a discreet solid or particles in suspension or in dispersion in a liquid, and comprising at least one, organic or inorganic, binder, load or pigment.

The size of the particles, characterized by the value D50, is typically between 20 nm and 5 μm.

Experts in the field know that items with non-stick properties very generally include a fluorinated polymer-based coating as a component. In particular, it is known that cooking tools equipped with a polytetrafluoroethylene (PTFE)-based coating make it possible to cook without requiring the addition of fat for cooking food, while making it very easy to clean the item. Moreover, it is widely acknowledged that fluorocarbon resins, and more specifically polytetrafluoroethylene (PTFE), are the most appropriate compounds for obtaining a coating with exceptional non-stick properties. The traditional techniques for decorating these coatings, such as tampography or serigraphy, do not make it possible to obtain hyper-realistic decorations, as the resolution is too limited.

Consequently, this invention aims to offer a method for manufacturing an item, particularly a cooking tool, equipped with a heat-stable non-stick coating and decorated with colored patterns that may be hyper-realistic, and with improved longevity with wear (chemical and mechanical resistance at high temperatures, which is to say greater than 200 ° C.).

More particularly, the purpose of this invention is a method for decorating an item including the following steps:
a.) Supply of a medium with two opposite surfaces;
b.) Application of a heat-stable coating particulate composition to one of the surfaces of the medium, to form a particulate sublayer, the particulate composition comprising at least one fluorocarbon resin, either alone or with a heat-stable coupling resin;
c.) Natural or forced drying of the particulate sublayer;
d.) Flexographic printing of a decoration on said particulate sublayer, including the printing (d1) of a first pigmented decoration composition on said particulate sublayer to form a first discontinuous decoration layer, said first decoration composition comprising at least one pigment with good thermal resistance; then,
e.) Solidifying heat treatment of the coated medium;
   in which:
α. The first pigmented decoration composition also comprises a fluorocarbon resin, the fusion or reticulation temperature of which is less than or equal to that of the fluorocarbon resin contained in the particulate sublayer, and/or
β. A step to apply a colorless finishing composition to form a colorless finishing layer is performed between the flexographic printing step (d) and the heat treatment step (e), the colorless finishing composition comprising at least one fluorocarbon resin, and/or
γ. The particulate sublayer is a highly absorbent sublayer.

The method described in the invention makes it possible to attain the objective stated in this invention due in particular to the joint use of one or more ink(s) that are resistant to high temperatures and a fluorocarbon resin-based heat-stable particulate sublayer, which makes it possible to achieve optimal adhesion between the sublayer and the one or more decoration layer(s) printed by flexography.

Additionally, the method in the invention makes it possible to remedy the disadvantages related to a double baking by using a single baking method that includes a drying step and a final baking. Indeed, since the sublayer is only dried, the fluorocarbon resin is not sintered when the decoration is applied; the sublayer thus possesses the quality of good printability. Furthermore, single baking makes for very good compatibility of the sublayer and the decoration, and is also very advantageous in terms of time and energy consumption.

In order to allow for the adhesion of the particulate compositions (or inks) printed by flexography on the particulate sublayer, while retaining good non-stick properties for the decoration thus formed, the method described in the invention requires the creation of at least one of the three alternative characteristics mentioned above (α through γ).

The different steps of the method described in the invention, as well as their preferred variations of implementation, will be described below.

Concerning the first step (a) of supplying a medium, the medium can be of any kind, provided that it is resistant to the temperatures required for the solidification of fluorocarbon resins.

If the medium is not in the final shape desired for the item and is in the shape of a pre-form, such as a disc, the method described in the invention will advantageously include a step (f) to shape the pre-form in order to obtain the desired shape of the item.

This shaping step (f) can be completed after the heat treatment step (e). It can also be done before the application step (b), and in this case the flexographic printing in step (d) would be performed only on the flat portion of the medium surface intended to be decorated.

The item that is decorated according to the method described in the invention may be a cooking tool, and specifically a cooking tool with a metal medium with an interior surface that can hold food and an exterior surface intended to be positioned facing the heat source.

In the case of a cooking tool, the medium can advantageously be:
A single-layer structure made of anodized or non-anodized aluminum, or of polished, brushed or microbead-blasted, sand-blasted or chemically treated aluminum, or of cast aluminum, or of polished, brushed or microbead-blasted stainless steel or of cast stainless steel, or of hammered or polished copper; or,
A multi-layer structure, in whole or in part, including the following layers from the exterior to the interior: stainless steel/aluminum/stainless steel, or stainless steel/aluminum/copper/aluminum/stainless steel, or a dome-shaped impression made of cast aluminum, aluminum or aluminum alloys lined with an exterior bottom made of stainless steel.

The surface of the medium intended to receive the decoration may undergo a surface treatment step (a′), so as to increase its specific surface area.

For a medium made of aluminum, this surface treatment can advantageously consist of anodization (creation of a tubular structure made of alumina), or chemical etching, or even sand-blasting, microbead-blasting, brushing or emery grinding, among others.

The other metal media may be polished, sand-blasted, brushed or microbead-blasted, for example, among others.

The method described in the invention comprises, following the medium supply step (a) (and as applicable, any shaping and/or surface treatment), a step to apply at least one heat-stable coating particulate composition to the surface of the medium intended to receive the decoration, leading to the formation of a heat-stable coating particulate sublayer.

The term “particulate sublayer” refers, for the purposes of the invention, to a sublayer obtained after the natural or forced drying of a particulate composition.

The term “pigmented decoration composition with good thermal resistance” refers, for the purposes of the invention, to a composition comprising a pigment with good thermal resistance.

The term “pigment with good thermal resistance” refers to a pigment with a color difference value (Delta E), measured at room temperature, of less than 1 after a 10-minute heat treatment at 410° C.±30 ° C.

The term “load with good thermal resistance” refers to a load for which the mass change does not exceed 5% after a 10-minute heat treatment at 410° C.±30° C.

The heat-stable coating particulate composition can be applied in the traditional spray-on manner, by curtain coating, serigraphy, roller, tampography, inkjet printing, or other method.

The particulate composition comprises at least one fluorocarbon resin, either alone or with a heat-stable coupling resin.

The particulate composition may also include at least one of the following: a load with good thermal resistance and a pigment with good thermal resistance.

For the fluorocarbon resin that can be used in the particulate composition described in the invention, we can mention, for example, polytetrafluoroethylene (PTFE), copolymer of tetrafluoroethylene and perfluoro-propylvinylether (PFA), copolymer of tetrafluoroethylene and hexafluoropropylene (FEP) and their mixtures.

For the heat-stable coupling resin that can be used in the heat-stable coating particulate composition described in the invention, we can mention, for example, polyimide-imides (PAI), polyether imides (PEI), polyimides (PI), polyetherketones (PEK), polyether ether ketones (PEEK), polyethersulfones (PES), polyphenylene sulfides (PPS) and their mixtures.

For pigments with good thermal resistance that can be used in the heat-stable coating particulate composition described in the invention, we can mention, for example, mineral pigments such as titanium dioxide, spinels, iron oxides, nickel titanate, carbon black, mica flakes, metal flakes (such as aluminum flakes) or organic pigments such as perylene reds. The pigments in this particulate composition are preferably chosen to obtain a light color.

For loads with good thermal resistance, we will use, for example, light-color loads, such as silica, talc, kaolin, barite and wollastonite.

The particulate sublayer thus formed must be dry prior to the flexographic printing of the first decoration layer, and this drying can be natural or forced, for example by infrared radiation or hot air convection.

The wettability of the dried particulate sublayer can also be improved through the use of a cold plasma or corona treatment, which promotes the spreading of the pigmented decoration layer over the sublayer.

Then, a decoration is printed by flexography on the particulate sublayer. This step includes the printing of a first pigmented decoration composition (or first ink), to form a first decoration layer, which is discontinuous.

Advantageously, the decoration printing step (d) can also include:
(d2) Natural or forced drying of the first decoration layer; then,
(d3) Flexographic printing of a second pigmented decoration composition comprising a second pigment with good thermal resistance (that can be the same as or different from the one in the first decoration layer), to form a second discontinuous decoration layer, said second decoration layer being superimposed on and/or juxtaposed with the first pigmented layer.

In this case, the decoration comprises two pigmented decoration layers.

The decoration can also comprise more than two decoration layers. The decoration printing step (d) then also includes the following steps:
(d4) Natural or forced drying of the (i−1)^{th} decoration layer applied to the medium; then,
(d3) The flexographic printing of an i^{th} pigmented decoration composition comprising an i^{th} pigment with good thermal resistance (that can be the same as or different from the one in the other decoration layers previously applied) to form an i^{th} discontinuous decoration layer, said i^{th} decoration layer being superimposed on and/or juxtaposed with the other decoration layers previously applied, these steps being repeated as many times as necessary to create the desired decoration (for example, to produce the desired number of colors).

If the decoration comprises four decoration layers of different colors, the decoration is referred to as “quadrichromatic.” If the decoration comprises six of them, it is called “hexachromatic.” The combination of all these layers of colors makes it possible to obtain a great variety of hues.

If the one or more decoration layers are not discontinuous and therefore form a total solid color completely covering the particulate sublayer, then there is no decoration. Indeed, a decoration is obtained by the visible contrast of color between the one or more decoration layers and the particulate sublayer.

The decoration compositions each comprise at least one pigment with good thermal resistance, preferably of a mineral nature.

For pigments that can be used in the decoration compositions described in the invention with good thermal resistance, we can mention, for example, mineral pigments such as titanium dioxide, spinels, iron oxides, nickel titanate, carbon black, coated mica flakes, metal flakes (such as aluminum flakes) or organic pigments such as perylene reds.

In characteristic α of the method described in the invention, the decoration compositions (or inks) comprise, in addition to the pigment with good thermal resistance, a fluorocarbon resin with a fusion or reticulation temperature of less than or equal to that of the fluorocarbon resin contained in the particulate sublayer.

For fluorocarbon resins that can be used in the decoration compositions described in the invention, we can mention, for example, polytetrafluoroethylene (PTFE), copolymer of tetrafluoroethylene and perfluoro-propylvinylether (PFA), copolymer of tetrafluoroethylene and hexafluoropropylene (FEP) and their mixtures.

Being of the same chemical nature, the decoration compositions (or inks) and the particulate sublayer thus have a strong mutual affinity, which ensures proper cohesion after baking, as the decoration also possesses the non-stick properties characteristic of fluorocarbon coatings.

In characteristic β of the method described in the invention, the method also comprises, between the decoration application step (d) and the solidifying heat treatment step (e), a step to apply a colorless finishing composition comprising at least one fluorocarbon resin on the decoration and, as applicable, on said particulate sublayer (when the decoration is discontinuous), to form a colorless finishing layer.

This colorless finishing layer serves to protect the decoration and to bind it to the particulate sublayer, while helping to improve the non-stick properties of the coating.

This colorless finishing layer may be coated in the traditional manner, by spray, curtain roller, serigraphy, roller, tampography, inkjet printing, or other means.

For fluorocarbon resins that can be used in the finishing composition described in the invention, we can mention, for example, polytetrafluoroethylene (PTFE), copolymer of tetrafluoroethylene and perfluoro-propylvinylether (PFA), copolymer of tetrafluoroethylene and hexafluoropropylene (FEP) and their mixtures.

In characteristic γ of the method described in the invention, a highly absorbent particulate sublayer is used.

The term “highly absorbent particulate sublayer” refers, for the purposes of this application, to a porous sublayer or one that contains loads that are intrinsically porous or that generate porosity by being combined at the time of drying, in order to allow for the absorption of color and/or of liquid phase from the decoration layers.

The highly absorbent sublayer has a degree of vacuum of at least 10% of the total volume of the material.

For intrinsically porous loads or ones that generate porosity, colloidal silica or colloidal alumina particles, porous silica particles or zeolite particles will preferably be used.

The particulate sublayer and the wet decoration are solidified in the decoration method described in the invention by a solidifying heat treatment of the coated medium.

The term “solidifying heat treatment” refers, for the purposes of this invention, to the application by any appropriate means of a heat flow intended to eliminate, in the deposited or printed layers, the solvents and/or volatile materials, and to melt and enable the coalescence of the resins contained in these layers, and also to reticulate these resins on themselves or amongst themselves as necessary.

Advantageously, the solidifying heat treatment (e) may consist of a baking performed (for example, in a traditional furnace) at a temperature of between 380° C. and 430° C.

The surface of the medium that is not decorated by flexography can also be coated with a fluorocarbon resin-based non-stick coating. The order in which the surfaces of the medium are coated is unimportant.

If the surface opposite the one intended to receive a decoration is coated with such a non-stick coating second (in other words, after the coating of the particulate sublayer and the decoration), the method described in the invention includes, prior to the solidifying heat treatment step (e):
Pre-baking of the medium coated with the particulate sublayer and the decoration; then,
Application of a non-stick coating to the surface of the medium opposite the one that receives the particulate sublayer and the decoration.

If the surface opposite the one intended to receive a decoration is coated with such a non-stick coating first (in other words, prior to the coating the particulate sublayer and the decoration), then the method described in the invention includes, between the supply step (a) (and as applicable, any shaping and/or surface treatment of the medium) and the application step (b):
Application of a non-stick coating to the surface of the medium opposite the one intended to receive the particulate sublayer and the decoration; then,
Pre-baking of the medium coated with the non-stick coating.

The method described in the invention offers the following advantages:

It is possible to create a non-stick decoration that can include very complex and/or hyper-realistic patterns (for example, photos, textures, imitation stone, wood, marble or fabric, among others);

With resolution that largely surpasses that which could be obtained with serigraphy or tampography;

While possessing non-stick and heat-stable properties that are significantly improved, as compared to those of the enamels usually used as a medium in flexography;

It is possible to create a decoration with very complex patterns from only four inks, which offers an undeniable advantage in terms of formulation and storage;

By printing the decoration using flexography, the printing speed is compatible with the fast pace at which items are manufactured;

And finally, it is possible to use existing flexography systems for printing enamels in the method described in the invention, without any major modifications to this equipment.

Other advantages and specific traits of this invention will become apparent in the description below, which is provided as a non-limiting example, in reference to the attached figures and the corresponding examples:

FIG. 1 shows a schematic view of an existing flexographic printing system used in the field of packaging;

FIG. 2 shows a schematic cross-section view of a cooking tool obtained in a first variation of implementation of the method described in the invention (see Example 1 and Comparative Example 1);

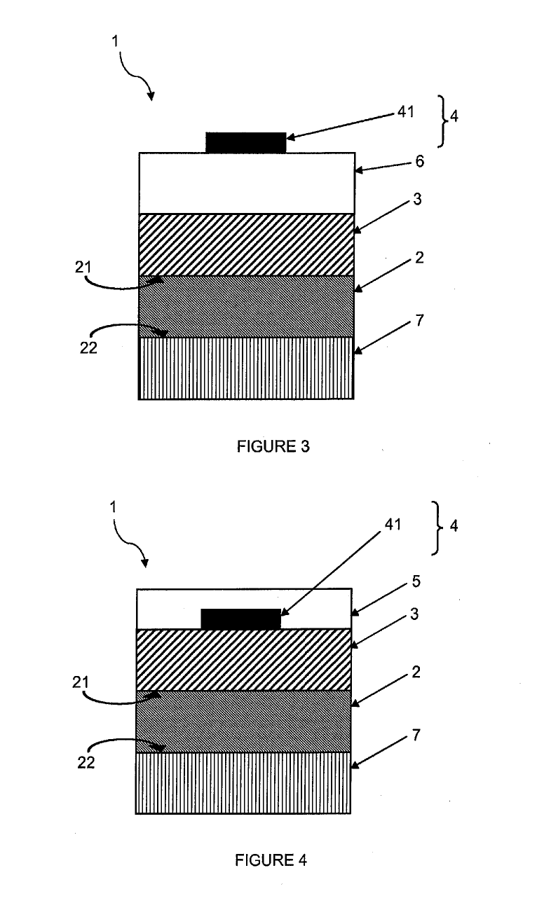

FIG. 3 shows a schematic cross-section view of a cooking tool obtained according to the second variation of implementation of the method described in the invention (see Example 2);

FIG. 4 shows a schematic cross-section view of a cooking tool obtained according to a third variation of implementation of the method described in the invention (see Example 3);

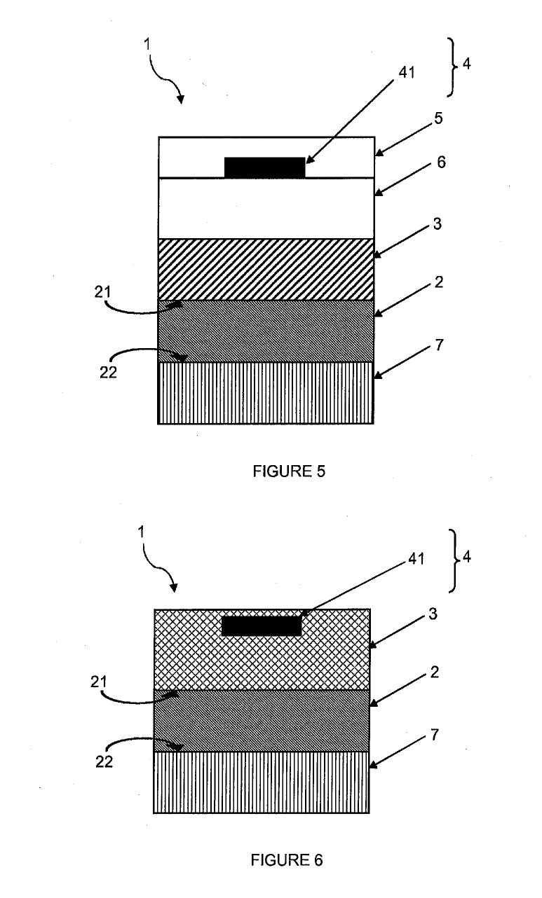

FIG. 5 shows a schematic cross-section view of a cooking tool obtained according to a fourth variation of implementation of the method described in the invention (see Example 4);

FIG. 6 shows a schematic cross-section view of a cooking tool obtained according to a fifth variation of implementation of the method described in the invention (see Example 5);

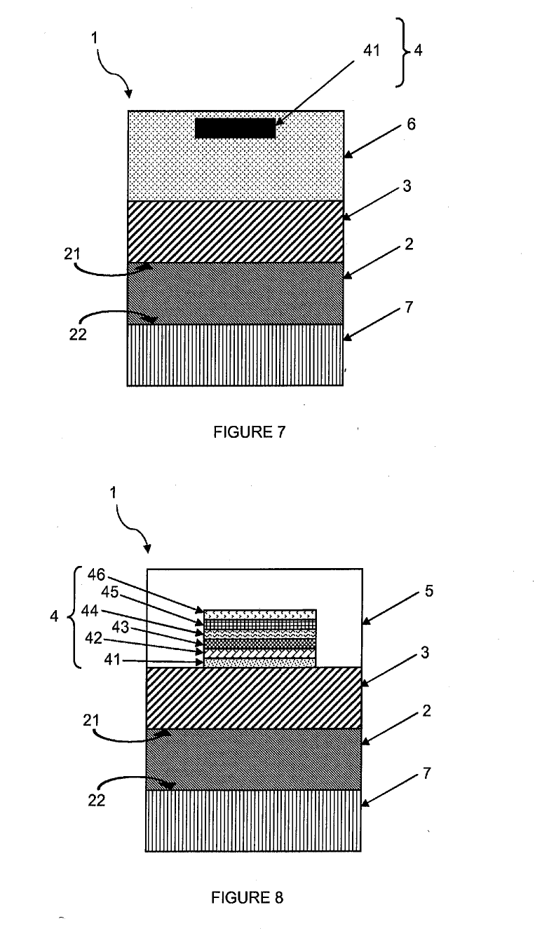

FIG. 7 shows a schematic cross-section view of a cooking tool obtained according to a sixth variation of implementation of the method described in the invention (see Example 6);

FIG. 8 shows a schematic cross-section view of a cooking tool obtained according to a seventh variation of implementation of the method described in the invention (see Example 7);

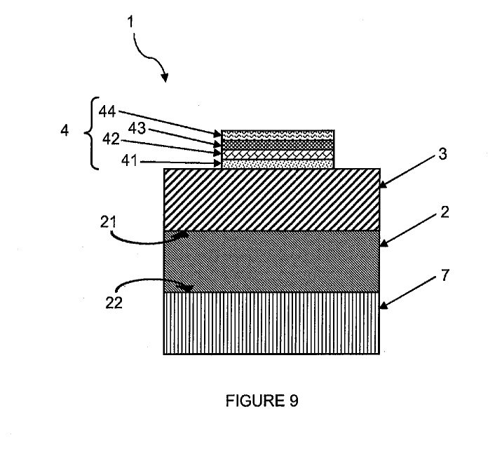

FIG. 9 shows a schematic cross-section view of a cooking tool obtained according to an eighth variation of implementation of the method described in the invention (see Example 8);

The same components depicted in FIGS. 2 through 9 are identified by the same reference numbers.

Commentary on the different variations of implementation depicted in FIGS. 2 through 9 can be found in the examples below.

In these examples, unless otherwise indicated, all percentages and portions are expressed by weight.

### EXAMPLES

Flexographic Decoration Device

The device depicted in FIG. 1, usually intended for printing on cardboard media, is used as a printing device.

Media

Aluminum discs that are 31 cm in diameter and 2.4 mm thick

Inks and Particulate Compositions

Products

Inorganic pigments: Temperature-stable mineral pigments such as titanium dioxide, spinels, iron oxides and nickel titanate

Defoaming agent: Product sold under the commercial name Dehydran G by the company Cognis

Wetting agent: Alkylphenol ethoxylate-type product sold under the commercial name Triton X-100 by the company Dow, or equivalent

Solvent: Propylene glycol

Acrylic resin thickener sold under the commercial name SD15 by the company Synthomer

PTFE dispersion at 60% dry extract, sold under the commercial name 5035Z by the company Dyneon

PFA Dispersion at 50% dry extract, sold under the commercial name 6900GZ by the company Dyneon

Colloidal silica: Product sold by the company Clariant under the commercial name Klebosol 47V50

Porous silica: Product sold by the company AGC under the commercial name Sunlovely

Formulation

The inks used for flexographic printing in the method described in the invention are aqueous formulations adapted for flexographic printing, as known to experts in the field. These formulations contain inorganic pigments that allow for good temperature resistance of the colors, and water as the main vehicle with at least one co-solvent (propylene glycol). These aqueous formulations are prepared from a pigment paste, as follows.

1) Preparation of a Pigment Paste

First, a pigment paste (PP) of a given color (including the color white) is prepared. This involves a dispersion, the composition of which is stated below in Table 1:

TABLE 1
Composition of the Pigment Paste (PP)

| Product | Quantity (% by weight) |
|---|---|
| Inorganic pigment | 49.6 |
| Water | 42 |
| Defoaming agent | 0.8 |
| Wetting agent | 5 |
| NH₄OH | 0.6 |
| Solvent | 2 |
| TOTAL | 100 |

This dispersion is prepared in a grinding mill (for example a ball mill) that can reduce the particle size of the pigments such that their D50 is less than 5 μm.

2) Preparation of a Fluorinated Aqueous Ink (Fluorinated Pigmented Decoration Ink or Composition 1)

From the pigment paste (PP), a first pigmented decoration ink or composition (1) is prepared as follows:

120 parts by weight of pigment paste (PP)

22.5 parts by weight of solvent

0.75 parts by weight of defoaming agent

1.5 parts by weight of NH₄OH

1.88 parts by weight of acrylic resin thickener, and

180 parts by weight of PTFE dispersion

This formula possesses physical properties (viscosity, drying speed) similar to those of a traditional ink used in flexography (viscosity 26 cP according to the AFNOR4 standard, density of 1.5 g/cm³).

3) Preparation of a Non-Fluorinated Aqueous Ink (Non-Fluorinated Pigmented Decoration Ink or Composition 2)

From the pigment paste (PP), a second non-fluorinated pigmented decoration ink or composition (2) is prepared as follows:

120 parts by weight of pigment paste (PP)

22.5 parts by weight of solvent

180 parts water

0.75 parts by weight of defoaming agent

1.5 parts by weight of NH₄OH, and

1.88 parts by weight of acrylic resin thickener.

This formula possesses physical properties (viscosity, drying speed) that are similar to those of a traditional ink used in flexography (viscosity 26 cP according to the AFNOR4 standard, density of 1.5 g/cm³).

4a) Preparation of a Pigmented Heat-Stable Coating Sublayer Particulate Composition (SC1)

From a white pigment paste (PP), as prepared in Point 1 with titanium dioxide as the inorganic pigment, a sublayer fluorinated particulate composition (SC1) is prepared, as stated in Table 2 below:

TABLE 2
White Sublayer Composition for Serigraphic Application (SC1)

| Product | Quantity (% by weight) |
|---|---|
| PP (TiO₂) | 20 |
| PTFE dispersion | 50 |
| Colloidal silica | 1 |
| Solvent | 10 |
| Water | 15 |
| Defoaming agent | 1 |
| Acrylic resin thickener | 2 |
| NH₄OH | 1 |
| TOTAL | 100 |

This formula possesses the standard physical properties (viscosity, drying speed) for serigraphic application (viscosity equal to 10,000 mPa·s at room temperature).

4b) Preparation of a highly absorbent, heat-stable coating sublayer particulate composition (SC2)

From a white pigment paste (PP) as prepared in Point 1 with titanium dioxide as the inorganic pigment, a highly absorbent sublayer fluorinated particulate composition (SC2) is prepared as stated in Table 3 below:

TABLE 3
Highly absorbent white sublayer composition
for serigraphic application (SC2)

| Product | Quantity (% by weight) |
|---|---|
| PP (TiO₂) | 10 |
| PTFE dispersion | 50 |
| Colloidal silica | 1 |
| Porous silica | 10 |
| Solvent | 10 |
| Water | 15 |
| Defoaming agent | 1 |
| Acrylic resin thickener | 2 |
| NH₄OH | 1 |
| TOTAL | 100 |

This formula possesses the standard physical properties (viscosity, drying speed) for serigraphic application (viscosity of 10,000 mPa·s at room temperature).

4c) Preparation of Colorless Heat-Stable Coating Sublayer Particulate Compositions (SC3 and SC4)

Colorless sublayer fluorinated particulate compositions (SC3, SC4) are prepared as stated in Tables 4 (SC3) and 5 (SC4) below:

TABLE 4
Colorless sublayer composition for serigraphic
and roller application (SC3)

| Product | Quantity (% by weight) |
|---|---|
| PTFE dispersion | 75 |
| Solvent | 15 |
| Water | 5 |
| Defoaming agent | 2 |
| Acrylic resin thickener | 2 |
| NH₄OH | 1 |
| TOTAL | 100 |

This formula possesses the standard physical properties (viscosity, drying speed) for serigraphic application (viscosity of 10,000 mPa·s at room temperature).

TABLE 5
Colorless sublayer composition for spray-on application (SC4)

| Product | Quantity (% by weight) |
|---|---|
| PTFE dispersion | 80 |
| PFA dispersion | 5 |
| Water-soluble acrylic | 0.5 |
| spreading agent | |
| Nonionic surfactant of the | 2 |
| alkylphenol ethoxylate type | |
| Water | 12.5 |
| TOTAL | 100 |

5) Preparation of Colorless Finishing Layer Compositions (CF1 and CF2)

Colorless finishing layer fluorinated particulate compositions (CF1, CF2) are prepared as stated in Tables 6 (CF1) and 7 (CF2) below:

TABLE 6
Finishing layer composition for serigraphic and roller application (CF1)

| Product | Quantity (% by weight) |
|---|---|
| PTFE dispersion | 75 |
| Solvent | 15 |
| Water | 5 |
| Defoaming agent | 2 |
| Acrylic resin thickener | 2 |
| NH₄OH | 1 |
| TOTAL | 100 |

This formula possesses the standard physical properties (viscosity, drying speed) for serigraphic application (viscosity of 10,000 mPa·s at room temperature).

TABLE 7
Colorless finishing layer composition for spray-on application (CF2)

| Product | Quantity (% by weight) |
|---|---|
| PTFE dispersion | 80 |
| PFA dispersion | 5 |
| Mica alumina flakes | 1 |
| Water-soluble acrylic | 0.5 |
| spreading agent | |
| Nonionic surfactant of the | 2 |
| alkylphenol ethoxylate type | |
| Water | 11.5 |
| TOTAL | 100 |

Test: Resistance and Transfer (Cohesion) Test

This test refers to Standard NF D 21-511. Cross-ruling (dimensions: 1 cm×1 cm) of 100 squares are drawn using a razor blade on the decoration.

An adhesive tape is applied and then pulled off, thereby making it possible:

1. To evaluate the cohesion of the decoration by looking for any lift-off, delamination or cleavage phenomena after the adhesive is pulled off;

2. To detect any color transfer of the decoration to the adhesive, by examining the sticky surface of the adhesive after the test.

### Example 1

Printing a Fluorinated Pigmented Heat-Stable Ink (Ink 1) on a PTFE-Based Pigmented Sublayer

Method of Implementation a.

Disc 2 thus coated and decorated corresponds to the one depicted in FIG. 2.

i. An aluminum disc (2) is prepared by chemical treatment in order to impart good coupling properties;

ii. Then, on one of the surfaces (21) of the disc (2), the pigmented particulate composition (SC1) is applied by serigraphy, to form a wet pigmented particulate sublayer (3);

iii. The particulate sublayer (3) is dried by infrared radiation; then,

iv. Fluorinated pigmented ink (1) is printed by flexography on the particulate sublayer (3), to form a discontinuous decoration layer (41), forming the decoration (4);

v. The disc (2) thus coated is pre-baked at a temperature of 350° C. for 8 minutes;

vi. Then, on the opposite surface (22) of the disc (2), a non-stick coating composition is applied by serigraphy (or by roller, inkjet printing, curtain roller or spray) to form a non-stick coating layer (7) that can be decorated or not;

vii. The disc (2) thus coated is baked at a temperature of 430CC for 8 minutes; and,

viii. The disc (2) thus coated is baked and press-formed into shape to obtain the desired form of the item (1).

Method of Implementation b.

The disc (2) thus coated and decorated also corresponds to the one depicted in FIG. 2.

i. An aluminum disc (2) is prepared by chemical treatment in order to impart good coupling properties;

ii. Then, on one of the surfaces (22) of the disc (2), a non-stick coating composition is applied by serigraphy (or by roller, inkjet printing, curtain roller or spray), to form a non-stick coating layer (7), which can be decorated or not;

iii. The disc (2) thus coated is pre-baked at a temperature of 350° C. for 8 minutes;

iv. Then, on the opposite surface (21) of the disc (2), the pigmented particulate composition (SC1) is applied by serigraphy, to form a wet pigmented particulate sublayer (3);

v. The particulate sublayer (3) is dried by infrared radiation; then,

vi. The fluorinated pigmented ink (1) is printed by flexography on the particulate sublayer (3) to form a discontinuous decoration layer (41), forming the decoration (4);

vii. The disc (2) thus coated is baked at a temperature of 430° C. for 8 minutes; and,

viii. The disc (2) thus coated is baked and press-formed into shape to obtain the desired form of the item (1).

For both methods of implementation in this example, the cohesion of the fluorinated decoration layer with the fluorinated particulate sublayer was evaluated using the resistance and transfer test described above. The result was 0% lift-off and no color transfer on the adhesive tape.

### Example 2

Printing of a Fluorinated Pigmented Heat-Stable Ink (Ink 1) on a PTFE-Based Colorless Sublayer

Method of Implementation a.

The disc (2) thus coated and decorated corresponds to the one depicted in FIG. 3.

i. An aluminum disc (2) is prepared by chemical treatment in order to impart good coupling properties;

ii. Then, on one of the surfaces (21) of the disc (2), the pigmented particulate composition (SC1) is applied by serigraphy, to form a wet pigmented particulate sublayer (3);

iii. The particulate sublayer (3) is dried; then,

iv. A colorless sublayer composition (SC3) is applied by serigraphy to the pigmented particulate sublayer (3), to form a colorless sublayer (6)

v. The colorless sublayer (6) is dried by infrared radiation; then,

The fluorinated pigmented ink (1) is printed by flexography on the colorless sublayer (6) to form a discontinuous decoration layer (41), forming the decoration (4);

vi. The disc (2) thus coated is pre-baked at a temperature of 350° C. for 8 minutes;

vii. Then, on the opposite surface (22) of the disc (2), a non-stick coating composition is applied by serigraphy (or by roller, inkjet printing, curtain roller or spray), in order to form a non-stick coating layer (7), which can be decorated or not;

viii. The disc (2) thus coated is baked at a temperature of 430° C. for 8 minutes; and,

ix. The disc (2) thus coated and baked is press-formed into shape to obtain the desired form of the item (1).

Method of implementation b.

This disc (2) thus coated and decorated also corresponds to the one depicted in FIG. 3.

i. An aluminum disc (2) is prepared by chemical treatment in order to impart good coupling properties;

ii. Then, on one of the surfaces (22) of the disc (2), a non-stick coating composition is applied by serigraphy (or by roller, inkjet printing, curtain roller or spray), to form a non-stick coating layer (7), which can be decorated or not;

iii. The disc (2) thus coated is pre-baked at a temperature of 350° C. for 8 minutes;

iv. Then, on the opposite surface (21) of the disc (2), the pigmented particulate composition (SC1) is applied by serigraphy, to form a wet pigmented particulate sublayer (3);

v. The particulate sublayer (3) is dried; then,

vi. The colorless sublayer composition (SC3) is applied by serigraphy on the particulate sublayer (3), to form a colorless sublayer (6);

vii. The colorless sublayer (6) is dried by infrared radiation;

viii. The fluorinated pigmented ink (1) is then printed by flexography on the colorless sublayer (6), to form a discontinuous decoration layer (41), forming the decoration (4);

ix. The disc (2) thus coated is baked at a temperature of 430° C. for 8 minutes; and,

x. The disc (2) thus coated and baked is press-formed into shape.

For both methods of implementation in this example, the cohesion of the fluorinated decoration layer on the PTFE-based colorless fluorinated sublayer was evaluated using the resistance and transfer test described above. The result was 0% lift-off and no color transfer on the adhesive tape.

### Example 3

Printing of a Non-Fluorinated Pigmented Heat-Stable Ink (Ink 2) on a PTFE-Based Pigmented Sublayer that is Protected by a Fluorinated Colorless Finishing Layer

Method of Implementation a.

The disc (2) thus coated and decorated corresponds to the one depicted in FIG. 4.

i. An aluminum disc (2) is prepared by chemical treatment in order to impart good coupling properties;

ii. Then, on one of the surfaces (21) of the disc (2), the pigmented particulate composition (SC1) is applied by serigraphy, to form a wet pigmented particulate sublayer (3);

iii. The particulate sublayer (3) is dried by infrared radiation; then,

The non-fluorinated pigmented ink (2) is printed by flexography on the particulate sublayer (3) to form a discontinuous decoration layer (41), forming the decoration (4);

iv. Then, the fluorinated finishing layer composition (CF1) is applied by serigraphy to the decoration layer (41), to form a finishing layer (5);

v. The disc (2) thus coated is pre-baked at a temperature of 350° C. for 8 minutes;

vi. Then, on the opposite surface (22) of the disc (2), a non-stick coating composition is applied by serigraphy (or by roller, inkjet printing, curtain roller or spray), to form a non-stick coating layer (7), which can be decorated or not;

vii. The disc (2) thus coated is baked at a temperature of 430° C. for 8 minutes; and,

viii. The disc (2) thus coated and baked is press-formed into shape to obtain the desired form of the item (1).

Method of Implementation b.

The disc (2) thus coated and decorated also corresponds to the one depicted in FIG. 4.

i. An aluminum disc (2) is prepared by chemical treatment in order to impart good coupling properties;

ii. Then, on one of the surfaces (22) of the disc (2), a non-stick coating composition is applied by serigraphy (or by roller, inkjet printing, curtain roller or spray), to form a non-stick coating layer (7), which can be decorated or not;

iii. The disc (2) thus coated is pre-baked at a temperature of 350° C. for 8 minutes;

iv. Then, on the opposite surface (21) of the disc (2), the pigmented particulate composition (SC1) is applied by serigraphy, to form a wet pigmented particulate sublayer (3);

v. The particulate sublayer (3) is dried by infrared radiation;

vi. The non-fluorinated pigmented ink (2) is printed by flexography on the particulate sublayer (3) to form a discontinuous decoration layer (41), forming the decoration (4);

vii. Then, the fluorinated finishing layer composition (CF1) is applied by serigraphy to the decoration layer (41), to form the finishing layer (5);

viii. The disc (2) thus coated is baked at a temperature of 430° C. for 8 minutes; and,

ix. The disc (2) thus coated and baked is press-formed into shape to obtain the desired form of the item (1).

For both methods of implementation in this example, the cohesion of the decoration layer protected by a fluorinated colorless finishing layer on the fluorinated particulate sublayer was evaluated using the resistance and transfer test described above. The result was 0% lift-off and no color transfer on the adhesive tape.

### Example 4

Printing of a Non-Fluorinated Pigmented Heat-Stable Ink (Ink 2) on a PTFE-Based Colorless Sublayer that is Protected by a Fluorinated Colorless Finishing Layer

Method of implementation a.

The disc (2) thus coated and decorated corresponds to the one depicted in FIG. 5.

i. An aluminum disc (2) is prepared by chemical treatment in order to impart good coupling properties;

ii. Then, on one of the surfaces (21) of the disc (2), the pigmented particulate sublayer composition (SC1) is applied by serigraphy, to form a wet pigmented particulate sublayer (3);

iii. The particulate sublayer (3) is dried; then,

iv. The colorless sublayer composition (SC3) is applied by serigraphy to the particulate sublayer (3), to form a colorless sublayer (6);

v. The non-fluorinated pigmented ink (2) is printed by flexography on the colorless sublayer (6) to form a discontinuous decoration layer (41), forming the decoration (4);

vi. Then, the finishing layer composition (CF1) is applied by serigraphy to the decoration layer (41), to form a finishing layer (5);

vii. The disc (2) thus coated is pre-baked at a temperature of 350° C. for 8 minutes;

Then, on the opposite surface (22) of the disc (2), a non-stick coating composition is applied by serigraphy (or by roller, inkjet printing, curtain roller or spray), to form a non-stick coating layer (7), which can be decorated or not;

viii. The disc (2) thus coated is baked at a temperature of 430° C. for 8 minutes; and,

ix. The disc (2) thus coated and baked is press-formed into shape to obtain the desired form of the item (1).

Method of Implementation b.

The disc (2) thus coated and decorated also corresponds to the one depicted in FIG. 5.

i. An aluminum disc (2) is prepared by chemical treatment in order to impart good coupling properties;

ii. Then, on one of the surfaces (22) of the disc (2), a PTFE-based non-stick coating composition is applied by serigraphy (or by roller, inkjet printing, curtain roller or spray), to form a non-stick coating layer (7), which can be decorated or not;

iii. The disc (2) thus coated is pre-baked at a temperature of 350° C. for 8 minutes;

iv. Then, on the opposite surface (21) of the medium (2), the pigmented particulate sublayer composition (SC1) is applied by serigraphy, to form a wet pigmented particulate sublayer (3);

v. The particulate sublayer (3) is dried; then,

vi. The colorless sublayer composition (SC3) is applied by serigraphy to the particulate sublayer (3), to obtain a colorless sublayer (6);

vii. The colorless sublayer (6) is dried;

viii. The non-fluorinated pigmented ink (2) is printed by flexography on the colorless sublayer (6), to form a discontinuous decoration layer (41), forming the decoration (4);

ix. Then, the fluorinated finishing layer composition (CF1) is applied by serigraphy to the decoration layer (41), to form the finishing layer (5);

x. The disc (2) thus coated is baked at a temperature of 430° C. for 8 minutes; and,

xi. The disc (2) thus coated and baked is press-formed into shape to obtain the desired form of the item (1).

For both methods of implementation in this example, the cohesion of the decoration layer, protected by a colorless finishing layer, on a PTFE-based colorless sublayer was evaluated using the resistance and transfer test described above. The result was 0% lift-off and no color transfer on the adhesive tape.

### Example 5

Printing a Non-Fluorinated Pigmented Heat-Stable Ink (Ink 2) on a PTFE-Based, Highly Absorbent Particulate Sublayer

Method of Implementation a.

The disc (2) thus coated and decorated corresponds to the one depicted in FIG. 6.

i. An aluminum disc (2) is prepared by chemical treatment in order to impart good coupling properties;

ii. Then, on one of the surfaces (21) of the disc (2), the highly absorbent pigmented particulate composition (SC2) is applied by serigraphy, to form a wet, highly absorbent, pigmented particulate sublayer (3);

iii. The particulate sublayer (3) is dried by infrared radiation; then,

iv. The non-fluorinated pigmented ink (2) is printed by flexography on the particulate sublayer (3) to form a discontinuous decoration layer (41), forming the decoration (4);

v. The disc (2) thus coated is pre-baked at a temperature of 350° C. for 8 minutes;

vi. Then, on the opposite surface (22) of the disc (2), a non-stick coating composition is applied by serigraphy (or by roller, inkjet printing, curtain roller or spray), to form a non-stick coating layer (7), which can be decorated or not;

vii. The disc (2) thus coated is baked at a temperature of 430° C. for 8 minutes; and,

viii. The disc (2) thus coated and baked is press-formed into shape to obtain the desired form of the item (1).

Method of Implementation b.

The disc (2) thus coated and decorated also corresponds to the one depicted in FIG. 6.

i. An aluminum disc (2) is prepared by chemical treatment in order to impart good coupling properties;

ii. Then, on one of the surfaces (22) of the disc (2), a non-stick coating composition is applied by serigraphy (or by roller, inkjet printing, curtain roller or spray), to form a non-stick coating layer (7), which can be decorated or not;

iii. The disc (2) thus coated is pre-baked at a temperature of 350° C. for 8 minutes;

iv. Then, on the opposite surface (21) of the medium (2), the highly absorbent pigmented particulate composition (SC2) is applied by serigraphy, to form a wet, highly absorbent, pigmented particulate sublayer (3);

v. The particulate sublayer (3) is dried by infrared radiation; then,

vi. The non-fluorinated pigmented ink (2) is printed by flexography on the particulate sublayer (3) to form a discontinuous decoration layer (41), forming the decoration (4);

vii. The disc (2) thus coated is baked at a temperature of 430° C. for 8 minutes; and,

viii. The disc (2) thus coated and baked is press-formed into shape to obtain the desired form of the item (1).

For both methods of implementation in this example, the cohesion of the decoration layer on a highly absorbent particulate sublayer was evaluated using the resistance and transfer test described above. The result was 0% lift-off and no color transfer on the adhesive tape.

### Example 6

Printing of a Non-Fluorinated, Pigmented, Heat-Stable Ink (Ink 2) on a PTFE-Based, Highly Absorbent, Particulate Sublayer

Method of Implementation a.

The disc (2) thus coated and decorated corresponds to the one depicted in FIG. 7.

i. An aluminum disc (2) is prepared by chemical treatment in order to impart good coupling properties;

ii. Then, on one of the surfaces (21) of the disc (2), the pigmented particulate composition (SC1) is applied by serigraphy, to form a wet, pigmented particulate sublayer (3);

iii. The particulate sublayer (3) is dried by infrared radiation; then,

iv. The highly absorbent, pigmented particulate composition (SC2) is applied by serigraphy to the particulate sublayer (3), to form a wet, highly absorbent, pigmented particulate sublayer (6);

v. The highly absorbent particulate sublayer (6) is dried by infrared radiation; then,

vi. The non-fluorinated, pigmented ink (2) is printed by flexography on the highly absorbent sublayer (6), to form a discontinuous decoration layer (41), forming the decoration (4);

vii. The disc (2) thus coated is pre-baked at a temperature of 350° C. for 8 minutes;

viii. Then, on the opposite surface (22) of the disc (2), a non-stick coating composition is applied by serigraphy (or by roller, inkjet printing, curtain roller or spray), to form a non-stick coating layer (7), which can be decorated or not;

ix. The disc (2) thus coated is baked at a temperature of 430° C. for 8 minutes; and,

x. The disc (2) thus coated and baked is press-formed into shape to obtain the desired form of the item (1).

Method of Implementation b.

The disc (2) thus coated and decorated also corresponds to the one depicted in FIG. 7.

i. An aluminum disc (2) is prepared by chemical treatment in order to impart good coupling properties;

ii. Then, on one of the surfaces (22) of the disc (2), a non-stick coating composition is applied by serigraphy (or by roller, inkjet printing, curtain roller or spray), to form a non-stick coating layer (7), which can be decorated or not;

iii. The disc (2) thus coated is pre-baked at a temperature of 350° C. for 8 minutes;

iv. Then, on the opposite surface (21) of the disc (2), the pigmented particulate composition (SC1) is applied by serigraphy, to form a wet pigmented particulate sublayer (3);

v. The particulate sublayer (3) is dried by infrared radiation; then,

vi. The highly absorbent pigmented particulate composition (SC2) is applied by serigraphy to the particulate sublayer (3), to form a wet, highly absorbent, pigmented particulate sublayer (6);

vii. The highly absorbent particulate sublayer (6) is dried by infrared radiation; then,

viii. The non-fluorinated pigmented ink (2) is printed by flexography on the highly absorbent sublayer (6) to form a discontinuous decoration layer (41), forming the decoration (4);

ix. The disc (2) thus coated is baked at a temperature of 430° C. for 8 minutes; and,

x. The disc (2) thus coated and baked is press-drawn into shape to obtain the desired form of the item (1).

For both methods of implementation in this example, the cohesion of the decoration layer on a highly absorbent particulate sublayer was evaluated using the resistance and transfer test described above. The result was 0% lift-off and no color transfer on the adhesive tape.

### Example 7

Hexachromatic Printing, on the Bottom of a Formed Piece, of Six Non-Fluorinated, Pigmented, Heat-Stable Inks on a Non-Pigmented Particulate Sublayer Protected by a Fluorinated, Colorless Finishing Layer

The disc (2) thus coated and decorated corresponds to the one depicted in FIG. 8.

i. For printing the decoration, inks are made in the colors yellow, cyan, magenta, green, orange and black by using different pigments, respectively, in a non-fluorinated pigmented ink (2);

ii. An aluminum disc (2) with two surfaces (21, 22) is drawn into shape to obtain the desired form of the item (1);

iii. The item (1) thus shaped undergoes a mechanical treatment (shot blasting using stainless steel beads) in order to impart good coupling properties;

iv. Then, an application of non-stick coating composition is sprayed onto the interior surface (22) of the item (1), to form a non-stick coating layer (7), which can be decorated or not;

v. The non-stick coating layer (7) is dried by infrared radiation; then,

vi. An application of the non-pigmented particulate composition (SC4) is sprayed onto the exterior surface (21) of the item (1) (on the skirt and the flat bottom), to form a wet particulate sublayer (3);

vii. The particulate sublayer (3) is dried by infrared radiation;

viii. A first non-fluorinated pigmented ink is printed by flexography on the flat part of the particulate sublayer (3), to form a first discontinuous decoration layer (41);

ix. A second non-fluorinated pigmented ink is printed by flexography on the first decoration layer (41), to form a second discontinuous decoration layer (42);

x. A third non-fluorinated pigmented ink is printed by flexography on the second decoration layer (42), to form a third discontinuous decoration layer (43);

xi. A fourth non-fluorinated pigmented ink is printed by flexography on the third decoration layer (43), to form a fourth discontinuous decoration layer (44);

xii. A fifth non-fluorinated pigmented ink is printed by flexography on the fourth decoration layer (44), to form a fifth discontinuous decoration layer (45);

xiii. A sixth non-fluorinated pigmented ink is printed by flexography on the fifth decoration layer (45) to form a sixth discontinuous decoration layer (46), the six decoration layers (41, 42, 43, 44, 45 and 46) forming the decoration (4);

xiv. Then, an application of the finishing composition (CF2) is sprayed on the entire exterior surface (21) of the item (1), to form a finishing layer (5); and,

xv. The item (1) thus coated on both surfaces (21, 22) is baked at a temperature of 430° C. for 8 minutes.

The cohesion of the non-fluorinated decoration layers on the particulate sublayer and under the fluorinated finishing layer was evaluated using the resistance and transfer test described above. The result was 0% lift-off and no color transfer on the adhesive tape.

### Example 8

Quadrichromatic Printing of Four Fluorinated, Pigmented, Heat-Stable Inks on a Non-Pigmented Particulate Sublayer

The disc (2) thus coated and decorated corresponds to the one depicted in FIG. 9.

i. For printing the decoration, inks are made in the colors yellow, cyan, magenta and black by using different pigments, respectively, in a fluorinated pigmented ink (1);

ii. An aluminum disc (2) is prepared by mechanical treatment (fine brushing by abrasive rollers) in order to impart good coupling properties;

iii. The non-pigmented particulate composition (SC3) is applied by roller to one of the surfaces (21) of the disc (2), to form a wet pigmented particulate sublayer (3);

iv. The particulate sublayer (3) is dried by infrared radiation; then,

v. A first fluorinated pigmented ink is printed by flexography on the particulate sublayer (3), to form a first discontinuous decoration layer (41);

vi. A second fluorinated pigmented ink is printed by flexography on the first decoration layer (41), to form a second discontinuous decoration layer (42);

vii. A third fluorinated pigmented ink is printed by flexography on the second decoration layer (42), to form a third discontinuous decoration layer (43);

viii. A fourth fluorinated pigmented ink is printed by flexography on the third decoration layer (43), to form a fourth discontinuous decoration layer (44), the four decoration layers (41, 42, 43 and 44) forming the decoration (4);

ix. The disc (2) thus coated and decorated is pre-baked at a temperature of 350° C. for 8 minutes;

x, Then, on the opposite surface (22) of the disc (2), a non-stick coating composition is applied by roller, to form a non-stick coating layer (7), which can be decorated or not;

xi. The disc (2) thus coated is baked at a temperature of 430° C. for 8 minutes; and,

xii. The disc (2) thus coated and baked is press-formed into shape to obtain the desired form of the item (1).

The cohesion of the fluorinated decoration layers on the particulate sublayer was evaluated using the resistance and transfer test described above. The result was 0% lift-off and no color transfer on the adhesive tape.

### Comparative Example 1

Printing a Non-Fluorinated, Pigmented, Heat-Stable Ink (Ink 2) on a PTFE-based Particulate Sublayer

The disc (2) thus coated and decorated corresponds to the one depicted in FIG. 2.

i. An aluminum disc (2) is prepared by chemical treatment, in order to impart good coupling properties;

ii. Then, on one of the surfaces (21) of the disc (2), the pigmented particulate composition (SC1) is applied by roller, to form a wet pigmented particulate sublayer (3);

iii. The particulate sublayer (3) is dried; then,

iv. The non-fluorinated pigmented ink (2) is printed by flexography on the particulate sublayer (3), to form a discontinuous decoration layer (41), forming the decoration (4);

v. The disc (2) thus coated is pre-baked at 380° C. for 5 minutes;

vi. Then, on the opposite surface (22) of the disc (2), a non-stick coating composition is applied by roller, to form a non-stick coating layer (7), which can be decorated or not;

vii. The disc (2) thus coated is baked at a temperature of 430° C. for more than 5 minutes;

viii. The disc (2) thus coated and baked is press-formed into shape to obtain the desired form of the item (1).

The non-stick property of the decoration is insufficient. The cohesion of the decoration layers on the particulate sublayer was evaluated using the transfer test described above. The result was significant color transfer on the adhesive tape.

1. Method for decorating an item including the following steps:
a) Supply of a medium with two opposite surfaces;
b) Application of heat-stable coating particulate composition to one of said surfaces of the medium, to form a particulate sublayer, said particulate composition comprising at least one fluorocarbon resin, alone or with a heat-stable coupling resin;
c) Natural for forced drying of said particulate sublayer;
d) Flexographic printing of a decoration on said particulate sublayer, including the printing of a first pigmented decoration composition on said particulate sublayer, to form a first discontinuous decoration layer, said first decoration composition comprising at least one pigment with good thermal resistance; then,
e) Solidifying heat treatment of the coated medium;
in which:
The first pigmented decoration composition also comprises a fluorocarbon resin, the fusion or reticulation temperature of which is less than or equal to that of the fluorocarbon resin contained in the particulate sublayer, and
Applying a colorless finishing composition, to form a colorless finishing layer is performed between the flexographic printing step and the heat treatment step, said colorless finishing composition comprising at least one fluorocarbon resin, and
The particulate sublayer is a highly absorbent sublayer.

2. Method described in claim 1, in which the particulate composition also comprises at least one of the following: a load with good thermal resistance and a pigment with good thermal resistance.

3. Method described in claim 1, also comprising, prior to the application step, a surface treatment step (a′) on the surface of the medium intended to be coated with the particulate sublayer and the decoration

4. Method described in any one of the previous claim 1, in which the fluorocarbon resin of the particulate composition, the fluorocarbon resin of the first decoration composition and the fluorocarbon resin of the finishing composition are independently chosen from among polytetrafluoroethylene (PTFE), copolymer of tetrafluoroethylene and perfluoro-propylvinylether (PFA), copolymer of tetrafluoroethylene and hexafluoropropylene (FEP) and their mixtures.

5. Method described in claim 1, in which the particulate composition comprises, in addition to the fluorocarbon resin, a heat-stable coupling resin chosen from polyimide-imides (PAI), polyetherimides (PEI), polyimides (PI), polyetherketones (PEK), polyether ether ketones (PEEK), polyethersulfones (PES), polyphenylene sulfides (PPS) and their mixtures.

6. Method described in claim 1,in which the drying in step (c) is performed in a forced manner by one of infrared radiation or hot air convection.

7. Method described in claim 1, wherein the pigment with good thermal resistance of the decoration composition is chosen from among mineral pigments, such as titanium dioxide, spinels, iron oxides, nickel titanate, carbon black, mica flakes, metal flakes or organic pigments such as perylene reds.

8. Method described in claim 1, in which the decoration printing step (d) also includes:
d2) Natural or forced drying of the first decoration layer; then,
d3) Flexographic printing of a second pigmented decoration composition comprising a second pigment with good thermal resistance, to form a second discontinuous decoration layer, said second decoration layer being superimposed upon and/or juxtaposed with the first pigmented layer.

9. Method described in claim 1, wherein the heat treatment in step (e) is a baking performed at a temperature of between 380° C. and 430° C.

10. Method described in claim 1, in which the medium exists in the form of a pre-form, said process also including a step (f) to shape the pre-form in order to obtain the desired form of the item.

11. Method described in claim 10, in which the shaping step (f) is performed after the heat treatment step (e).

12. Method described in claim 10, in which the shaping step is performed before the application step (b), in which case the flexographic printing step (d) is performed only on a flat part of the surface.

13. Method described in claim 1, also including, prior to the heat treatment step (e):
Pre-baking of the medium coated with the particulate sublayer and the decoration; then,
Application of a non-stick coating to the surface of the medium opposite the surface receiving the particulate sublayer and the decoration.

14. Method described in claim 1, also including, between step (a) to supply the medium and the application step (b):
Application of a non-stick coating to the surface of the medium opposite the surface intended to receive the particulate sublayer and the decoration; then,
Pre-baking of the medium coated with the non-stick coating.

15. Method described in claim 1, in which the item is a cooking tool with a metal medium having an interior surface that can hold food and an exterior surface intended to be positioned facing heat source.

16. Method described in claim 15, in which the medium is:
A single-layer structure made from one of anodized or non-anodized aluminum, or of polished, brushed or microbead-blasted, sand-blasted or chemically treated aluminum, or of cast aluminum, or of polished, brushed or microbead-blasted stainless steel, or of cast stainless steel, or of hammered or polished copper; or,
A multi-layer structure, in whole or in part, including the following layers from the exterior to the interior: stainless steel/aluminum/stainless steel, or stainless steel/aluminum/copper/aluminum/stainless steel, or a dome-shaped impression made of cast aluminum, aluminum or aluminum alloys lined with an exterior bottom made of stainless steel.

17. Method described in claim 2, wherein the pigment with good thermal resistance of the particulate, sublayer is chosen from among mineral pigments, such as titanium dioxide, spinels, iron oxides, nickel titanate, carbon black, mica flakes, metal flakes or organic pigments such as perylene reds.
